(19) United States
(12) Patent Application Publication
(10) Pub. No.: US 2003/0114174 A1
(43) Pub. Date: Jun. 19, 2003

(54) Mobile telephone short text messaging with message thread identification

(76) Inventors: Brian Walsh, Woodinville, WA (US); Thomas Cast, Redmond, WA (US); Feza Buyukdura, Woodinville, WA (US)

Correspondence Address: IPSOLON LLP, 805 SW BROADWAY, #2740, PORTLAND, OR, 97205, US

(21) Appl. No.: 10/024,833

(22) Filed: Dec. 19, 2001

(51) Int. Cl. H04Q 7/20

(52) U.S. Cl. 455/466; 455/412

(57) ABSTRACT

Electronic messaging in a one-to-one, one-to-many, or many-to-many messaging session is directed through a short text messaging application. The short text messaging application incorporates a message thread identifier with a message that is sent to a recipient or group of recipients. The message thread identifier may be embedded in the header information of the message, for example, and is associated with the unique user identification code or network address of each recipient. Any reply to such a message is directed to the originating user and any other recipients based upon the message thread identifier.

### TECHNICAL FIELD

The present invention relates to mobile telephone short text messaging and, in particular, relates identification of message threads in short text messaging, thereby facilitating reply messaging between users.

### BACKGROUND AND SUMMARY

Mobile telephone systems include a variety of services and functions beyond simple direct voice communication. One such service is short text messaging in which short text messages, sometimes of up to a maximum length, are sent between mobile telephones and other digital devices in accordance with a mobile telephone short message service (SMS) standard (e.g., GSM Phase 1).

Instant messaging is a communication service that is similar to a mobile telephone short message service, but with instant messaging users commonly use a personal computer as the client communication device. Mobile telephone short message services and instant messaging are similar in that a message originator composes a message (i.e., on a specialized telephone or computer, respectively) and sends the message across a communication network to a recipient. In both methods of electronic messaging, the message originator directs the message to the recipient by specifying a unique identification number, such as a telephone number, that is associated with the recipient.

Upon receipt, the recipient may choose to respond to the originator. In most instant messaging systems, a “reply” feature allows the recipient to easily send a return message to the message originator by pressing a reply button. In some systems, such as short text messaging between two telephones, the telephone number of the message originator is embedded within the electronic information sent to the recipient. It is a straightforward operation to collect this information and use it as an address in a reply message. In other systems, however, such as short text messaging between a computer and a telephone, the address of the message originator may not be present in the electronic information sent to the recipient. In this instance, the message originator must type his identification information within the body of the message text (e.g., “Send all replies to 555-1234”) for the information to be available to the recipient.

To simplify reply messaging in mobile telephone short message text messaging, the present invention provides a unique identification code that allows the recipient of a message to quickly, or transparently, send a response to a message originator. For messaging between a group of users, the identification code also allows copies of the response to be sent to any other recipients of the originating message.

In one implementation, a unique user identification code or “handle” is designated for each of multiple short text message network addresses (e.g., mobile telephone numbers) and identifies message system users or groups of them. Each unique identification code can occupy less space (i.e., be of fewer characters) than the corresponding communication network address and so can be more convenient for message system users to access or use.

Electronic messaging in a one-to-one, one-to-many, or many-to-many messaging session is directed through a short text messaging application. The short text messaging application incorporates a message thread identifier with a message that is sent to a recipient or group of recipients. The message thread identifier may be embedded in the header information of the message, for example, and is associated with the unique user identification code or network address of each recipient. Any reply to such a message is directed to the originating user and any other recipients based upon the message thread identifier.

Additional objects and advantages of the present invention will be apparent from the detailed description of the preferred embodiment thereof, which proceeds with reference to the accompanying drawings.

### BRIEF DESCRIPTION OF THE DRAWINGS

FIG. 1 is a functional block diagram of a short text messaging system of a mobile telephone network to illustrate an operating environment of the present invention.

FIGS. 2A and 2B show a flow diagram of a short message reply method by which a message thread is automatically identified to facilitate replies to short text messages.

FIG. 3 is an illustration of successive data structures used in the short message reply method of FIG. 2.

### DETAILED DESCRIPTION OF PREFERRED EMBODIMENT

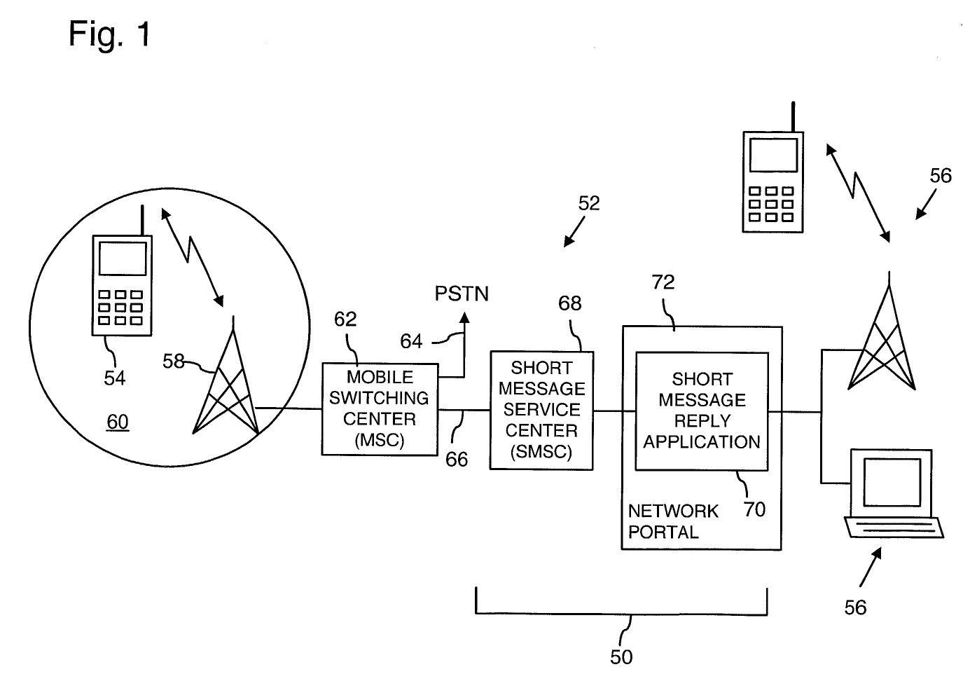

FIG. 1 is a functional block diagram of a text messaging system 50 of a mobile telephone network 52 to illustrate an operating environment of the present invention. An exemplary mobile telephone 54 is shown as being in wireless or radiated communication with mobile telephone network 52.

Text messaging system 50 supports a short text message service by which short text messages, in some cases of up to a maximum length, may be transmitted or received by mobile telephones, such as mobile telephone 54. As an example, the short text message service could include or conform to the short message service (SMS) standard that is part of the GSM Phase 1 standard, or any other wireless communication SMS standard. One SMS standard allows transmission of fixed length text messages of up to about 160 characters in length.

Text messages are conveyed between mobile telephone 54 and another text messaging device 56 via text messaging system 50. Messaging device 56 may be of any type compatible with or employing short length text messaging, including mobile telephones, networked personal computers, handheld computing or digital devices, or any other such device. It will be appreciated that such text messages may also be transmitted between messaging devices 56 that do not include a mobile telephone 54. The description of text messaging system 50 as including mobile telephone 54 is merely an example of one configuration.

Mobile telephone network 52 includes a wireless or radiating transceiver station 58 that corresponds to a communication cell 60, and mobile telephone network may include one or more cells. Mobile telephone 54 within cell 60 communicates with mobile telephone network 52 via a wireless or radiating link with transceiver station 58. Transceiver station 58 communicates with a mobile switching center 62 that directs communications between mobile telephone 54 and various communication channels, including a public-switched telephone network channel 64 and a short text message channel 66.

Short text message channel 66 includes a short message service center 68 that is in networked communication with mobile switching center 62. Short message service center 68 functions to direct short text messages between mobile telephone 54 and text messaging device 56 via a computer network. Likewise, short message service center 68 functions to direct text information to one or more messaging applications, such as a short text instant messaging application 70 according to the present invention. Mobile switching center 62 and short message service center 68 may be located together or may be remote from each other, as is known in the art.

Short text instant messaging application 70 functions to identify a thread of text message communication between two or more messaging devices such as mobile telephone 54 and text messaging device 56. Short text instant messaging application 70 may operate at a computer network portal 72, for example, that is in computer network communication with short message service center 68 and any other networked devices (e.g., text messaging device 56).

It will be appreciated that mobile switching center 62, short message service center 68, and network portal 72 may each be implemented with one or more specialized or general-purpose computer systems. Such systems commonly include a high speed processing unit (CPU) in conjunction with a memory system (with volatile and/or non-volatile memory), an input device, and an output device, as is known in the art.

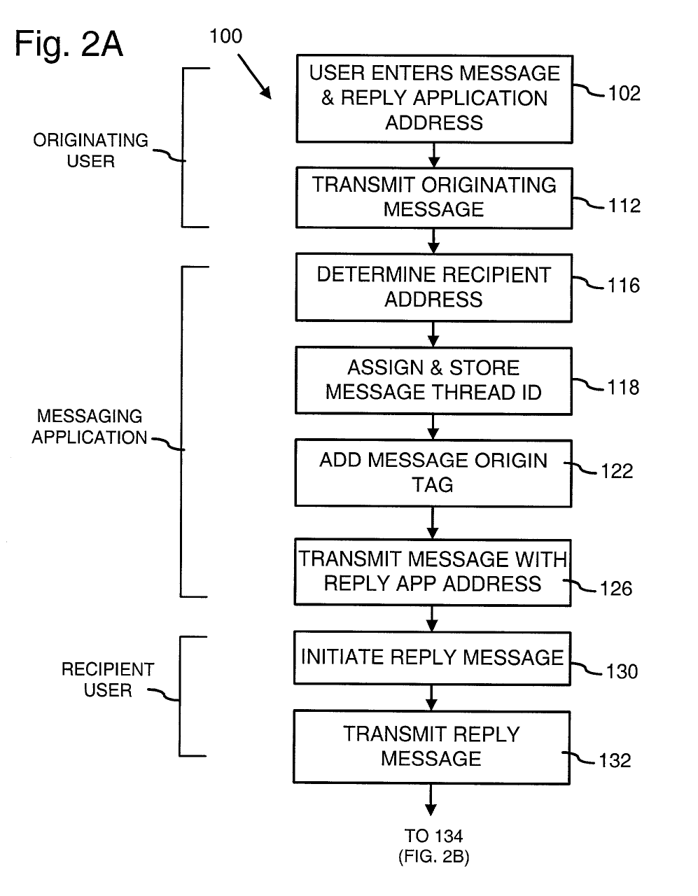

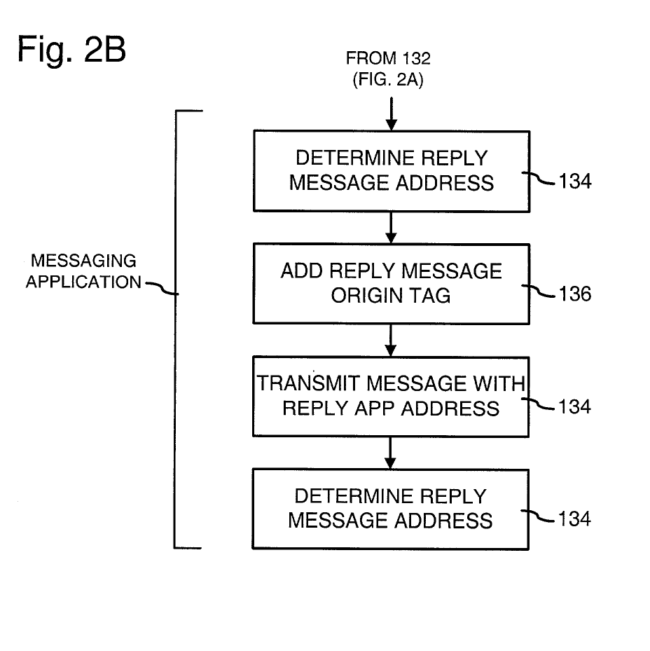

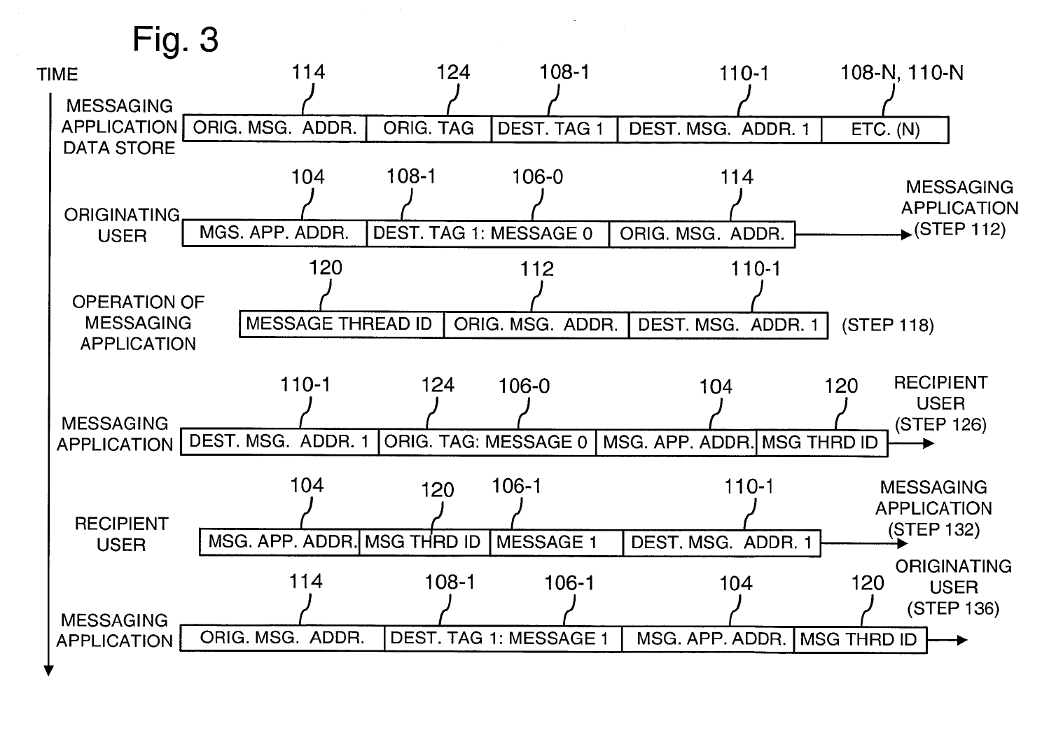

FIGS. 2A and 2B (FIG. 2) show a flow diagram of a short message reply method 100 by which a message thread is automatically identified to facilitate replies to short text messages. Short message reply method 100 illustrates operation of short text instant messaging application 70 in connection with short text messaging between at least a pair of users. The following description of FIG. 2 references features shown in FIG. 3, which illustrates successive data structures used in short message reply method 100.

One user is referred to as a message originating user and another user is referred to as the recipient user, destination, or “buddy.” These designations are used merely to distinguish the users for purposes of clarity. It will be appreciated that either user could function as the originator or recipient.

Process block 102 indicates that a message-originating user enters into a text messaging device (e.g., mobile telephone 54) a short message address 104, corresponding to short text instant messaging application 70, and a short text message 106-0 that includes a short message destination tag 108-1. The “0” suffix of short text message 106-0 indicates that it is the initial message in a message thread with an arbitrary number of messages. The “1” suffix of short message destination tag 108-1 indicates that it is one of an arbitrary number N of available destination tags.

In one implementation, short message destination tag 108-1 is a predefined name or handle of an intended recipient of short text message 106-0. Short message destination tag 108-1 may be identified within text message 106-0 by a predefined position in text message 106-0 (e.g., the beginning) or a predefined string of leading and/or following text characters. Short message destination tag 108-1 incorporates or is correlated with a short message address 110-1 (e.g., mobile telephone number) for the intended recipient. Listed below are exemplary implementations of composing a short text message 106-0 that includes a short message destination tag 108-1.

When composing a message to a recipient user or “buddy,” the originating user may:

a. Choose a compose option on the originating user text messaging device (e.g., mobile telephone 54).

b. Enter a short message destination tag 108-1 (e.g., “BuddyHandle”) into a message body field, followed by a space (i.e., a space character, designated as <space>), such as:

BuddyHandle<space>

c. Enter a short text message 106-0 after short message destination tag 108-1 and preceded by a space, such as:

BuddyHandle<space>Hi, want to go to lunch?

d. Press a Send control key and enter a unique destination number for instant messaging application 70. This number may be defined by the operator of text messaging system 50 or mobile telephone network 52 and, in one implementation, could be a 4-digit code such as 5555 (i.e., short message address 104).

When composing a message to a recipient instant messaging group, the originating user may:

a. Choose a compose option on the originating user text messaging device (e.g., mobile telephone 54).

b. Enter a short message destination tag 108-1 (e.g., “GroupHandle”) for the messaging group into a message body field, followed by a space (i.e., a space character, designated as <space>), such as:

GroupHandle<space>

c. Enter a short text message 106-0 after short message destination tag 108-1 and preceded by a space, such as:

GroupHandle<space>Golf tee time at 12pm?

d. Press a Send control key and enter a unique destination number for instant messaging application 70. This number may be defined by the operator of text messaging system 50 or mobile telephone network 52 and, in one implementation, could be a 4-digit code such as 5555 (i.e., short message address 104).

When composing a message to a recipient user or “buddy” in an external community such as Microsoft Network (MSN)™ or America Online (AOL)™ the originating user may:

a. Choose a compose option on the originating user text messaging device (e.g., mobile telephone 54).

b. Enter a short message destination tag 108-1 with an external domain identifier (e.g., “BuddyHandle.aol”) into a message body field, followed by a space (i.e., a space character, designated as <space>), such as:

BuddyHandle.msn<space>

c. Enter a short text message 106-0 after short message destination tag 108-1 and preceded by a space, such as:

BuddyHandle.msn<space>Hi Buddy?

d. Press a Send control key and enter a unique destination number for instant messaging application 70. This number may be defined by the operator of text messaging system 50 or mobile telephone network 52 and, in one implementation, could be a 4-digit code such as 5555 (i.e., short message address 104).

When composing a message to multiple recipients or buddies in a multi-user chat session, the originating user may:

a. Choose a compose option on the originating user text messaging device (e.g., mobile telephone 54).

b. Enter a short message destination tag 108-1 (e.g., “buddy1, buddy2, etc.”) for each intended recipient into a message body field, followed by a space (i.e., a space character, designated as <space>), such as:

buddy1,buddy2,buddy3<space>

c. The user shall include the text message to be sent. This shall follow the IM handles and be preceded by a space. I.e.

buddy1,buddy2,buddy3<space>Hi, want to go to lunch?

d. Press a Send control key and enter a unique destination number for instant messaging application 70. This number may be defined by the operator of text messaging system 50 or mobile telephone network 52 and, in one implementation, could be a 4-digit code such as 5555 (i.e., short message address 104).

When requesting a list of predefined buddies who are currently active be downloaded to a messaging device (e.g., mobile telephone 54) from instant messaging application 70, the originating user (or any other user) may:

a. Choose a compose option on the originating user text messaging device (e.g., mobile telephone 54).

b. Enter into a message body field a predefined keyword (e.g., STATUS IM”), such as:

STATUS IM

c. Press a Send control key and enter a unique destination number for instant messaging application 70. This number may be defined by the operator of text messaging system 50 or mobile telephone network 52 and, in one implementation, could be a 4-digit code such as 5555 (i.e., short message address 104).

The list of predefined buddies may be downloaded to instant messaging application 70 directly from a user messaging device (e.g., mobile telephone 54) or a personal computer operating associated client software.

Table 1 summarizes exemplary originating user operations for various messaging functions.

TABLE 1

| | | | | User |
|---|---|---|---|---|
| | Destination | Originating | | Required to |
| Function | Address | Address | SMS Body | Enter |
| IM | ‘5555’ | MIN | IM handle | Dest |
| | | (originating) | (space) | Address, |
| | | | Alphanumeric | IMhandle & |
| | | | text | Text body |
| Group Chat | ‘5555’ | MIN | Group Name | Dest |
| | | (originating) | (space) | Address, |
| | | | Alphanumeric | Group Name |
| | | | text | or number & |
| | | | | Text body |
| IM with | ‘5555’ | MIN | IM | Dest |
| External | | (originating) | handle.External | Address, |
| Community | | | (space) | IM handle, |
| | | | Alphanumeric | Extension |
| | | | text | for external |
| | | | | community |
| | | | | & Text body |
| Multi-User | ‘5555’ | MIN | IM handle1, | Dest |
| IM | | (originating) | Imhandle2, | Address, |
| | | | Imha | IMhandles & |
| | | | ndle3(space) | Text body |
| | | | Alphanumeric | |
| | | | text | |
| Buddy | ‘5555’ | MIN | STATUS IM | Dest |
| Download | | (originating) | keywords | Address, |
| | | | | keywords |

Process block 112 indicates that the message-originating user transmits the short text message 106-0, which is directed to short text instant messaging application 70 by mobile telephone network 52 in accordance with short message address 104. As is common, transmission of the short text message 106-0 includes transmission of the short message address 114 (e.g., mobile telephone number) of the message-originating user.

Process block 116 indicates that short text instant messaging application 70 determines a short message address 110-1 (e.g., a mobile telephone number) of the intended recipient from the short message destination tag 108-1. For example, short text instant messaging application 70 includes a database or other data store that correlates message destination tags 108 and corresponding short message addresses 110. The top line of FIG. 3 indicates that an arbitrary N-number of such message destination tags 108 (i.e., buddy handles) and corresponding short message addresses 110 could be stored in association with message address 114 of the originating user. In addition, message destination tags 108 (i.e., buddy handles) may be stored on a user's short message device (e.g., mobile telephone 54) as part of an e-mail address book or as a separate address book, for example.

Process block 118 indicates that short text instant messaging application 70 assigns and stores in its data storage a message thread identifier 120 (sometimes referred to as a chat session identifier) that corresponds to and identifies the message from the originating user and is associated with the message-originating user short message address 114 and the destination short message address 110-1 of the recipient user.

Process block 122 indicates that short text instant messaging application 70 incorporates into or associates with short text message 106-0 a short message origination tag 124, or handle, that identifies the originating user, as well as a group identifier if the message originated from within a group. In addition, short text instant messaging application 70 incorporates message thread or “chat” identifier 120, such as into a message header.

Process block 126 indicates that short text instant messaging application 70 transmits to the intended recipient short text message 106-0 with short message origination tag 124 and a return short message address corresponding to short text instant messaging application 70. The transmission is directed to the short message address 110-1 corresponding to short message destination tag 108-1. Upon receipt, short text message 106-0 is readable by the recipient user.

Process block 130 indicates that the recipient user initiates creation of a reply short text message 106-1 to the originating user. In one implementation, creation of reply short text message 106-1 may be initiated by the recipient user selecting or otherwise indicating the short message origination tag 124. Initiation of reply short message 106-1 opens a new short text message screen in which the recipient user can enter a text for reply short message 106-1 to be sent to the originating user. Reply short message 106-1 includes short message origination tag 124 and is directed to the return short message address 104 corresponding to short text instant messaging application 70.

When replying to a short message 106-0 received from an originating buddy, the recipient user may:

a. Choose a Reply option on the recipient user text messaging device (e.g., device 56).

b. Enter a short text message 106-1 to be sent, such as:

Sure, How about lunch at 1:00 pm.

c. Press Send. The recipient user text messaging device (e.g., device 56) automatically populates the destination address with instant messaging application address 104 (e.g., a 4-digit address such as 5555), together with an N-digit (e.g., 4) suffix corresponding to message thread identifier 120. For example, the destination address may be of the form “5555-xxxx,” by which instant messaging application 70 can uniquely identify the message thread/chat session.

This format enables the receiving user to reply via a short text message or with a call back to an embedded phone number. The reply function allows the user to respond to any mobile-terminated short message directly without requiring the user to include an instant message handle or group name in the reply text. Table 2 summarizes exemplary replying user operations for various messaging functions.

TABLE 2

| | | | | User |
|---|---|---|---|---|
| | Destination | Originating | | Required to |
| Function | Address | Address | SMS Body | Enter |
| IM | ‘5555-xxxx’ | MIN | Alphanumeric | Text body |
| | | (originating) | text | |
| Group Chat | ‘5555-xxxx’ | MIN | Alphanumeric | Text body |
| | | (originating) | text | |
| IM & | ‘5555-xxxx’ | MIN | Alphanumeric | Text body |
| External | | (originating) | text | |
| Community | | | | |
| Multi-User | ‘5555-xxxx’ | MIN | Alphanumeric | Text body |
| Chat | | (originating) | text | |

Process block 132 indicates that the recipient user transmits the reply short message 106-1, which is directed to short text instant messaging application 70. Transmission of the short text message 106-1 includes transmission of the short message thread identifier 120.

Process block 134 indicates that short text instant messaging application 70 identifies from the message thread identifier 120 the short message address 114 of the originating user as the reply address to which reply short message 106-1 is directed.

Process block 136 indicates that short text instant messaging application 70 incorporates into or associates with short text message 106-1 a short message tag 108-1 that identifies the replying user.

Process block 138 indicates that short text instant messaging application 70 transmits to the reply short text message 106-1 with short message tag 108-1, a return short message address 104 corresponding to short text instant messaging application 70, and message thread identifier 120. The transmission is directed to the originating short message address 114. Upon receipt, short text message 106-1 is readable by the originating user.

Short message reply method 100 and short text instant messaging application 70 function to identify a thread of text message communication between two or more short text messaging devices such as mobile telephone 54 and text messaging device 56. Short message reply method 100 and short text instant messaging application 70 allow a message thread to be automatically identified without user interaction to facilitate replies to short text messages.

In accordance with the practices of persons skilled in the art of computer programming, the present invention is described below with reference to acts and symbolic representations of operations that are performed by such computer systems, unless indicated otherwise. Such acts and operations are sometimes referred to as being computer-executed and may be associated with the operating system or the application program as appropriate. It will be appreciated that the acts and symbolically represented operations include the manipulation by the CPU of electrical signals representing data bits which causes a resulting transformation or reduction of the electrical signal representation, and the maintenance of data bits at memory locations in the memory systems to thereby reconfigure or otherwise alter operation of the computer systems, as well as other processing of signals. The memory locations where data bits are maintained are physical locations that have particular electrical, magnetic, or optical properties corresponding to the data bits.

In view of the many possible embodiments to which the principles of this invention may be applied, it should be recognized that the detailed embodiments are illustrative only and should not be taken as limiting the scope of the invention. Rather, I claim as my invention all such embodiments as may come within the scope and spirit of the following claims and equivalents thereto.

1. A mobile telephone short text messaging method for transmitting short text messages of a message thread between short text messaging devices of an originating user and a recipient user, the originating user beginning the message thread with an originating short text message that is directed to the recipient user, the method comprising:
transmitting the originating short text message from the short text messaging device of the originating user to a short text messaging application;
correlating at the short text messaging application a message thread identifier with the originating short text message and a messaging address for the short text messaging device of the originating user;
transmitting the originating short text message to the short text messaging device of the recipient user and transmitting therefrom a reply short text message to the short text messaging application;
identifying the message thread identifier and the messaging address for the short text messaging device of the originating user corresponding to the reply short text message; and
transmitting reply short text message to the short text messaging device of the originating user.

2. The method of claim 1 in which the short text messaging device of the recipient user is uniquely identified by a short text message address, a message destination tag being included with the originating short text message and identifying the recipient user with an indication other than the short text message address.

3. The method of claim 2 further comprising storing with the short text messaging application the message destination tag in association with short text message address of the short text messaging device of the recipient user.

4. The method of claim 2 in which the message destination tag is included in the originating short text message sent by the originating user.

5. The method of claim 4 in which the message destination tag is located in a predefined location in the originating short text message.

6. The method of claim 1 in which the short text messaging device of the originating user is uniquely identified by a short text message address, the message thread identifier being included with the reply short text message and allowing identification of the originating user with an indication other than the short text message address of the originating user messaging device.

7. The method of claim 1 in which at least one of the short text messaging devices of the originating and recipient users is a mobile telephone.

8. In a short text messaging system of a mobile telephone network having a short message service center that directs short text messages between short text messaging devices, the improvement comprising:
a short text messaging application that is in a computer readable medium and that correlates a message thread identifier with short text messages transmitted between short text messaging devices of an originating user and a recipient user, the originating user beginning a message thread with an originating short text message that is directed to the recipient user, the message thread identifier identifying messaging addresses for the short text messaging devices of the originating and recipient users.

9. The system of claim 8 in which the short text messaging device of a recipient user is uniquely identified by a short text message address, a message destination tag being included with the originating short text message and identifying the recipient user with an indication other than the short text message address.

10. The system of claim 9 further comprising software that is in a computer readable medium for storing with the short text messaging application the message destination tag in association with short text message address of the short text messaging device of the recipient user.

11. The system of claim 8 in which the short text messaging device of the originating user is uniquely identified by a short text message address, the message thread identifier being included with the reply short text message and allowing identification of the originating user with an indication other than the short text message address.

12. The system of claim 11 further comprising software in a computer readable medium for storing with the short text messaging application the message originating tag in association with short text message address of the short text messaging devices of the originating user.

13. The media of claim 8 in which short text messaging application resides in a network portal that is accessible by a short message service center.

14. The system of claim 8 in which the message thread identifier correlates short text messages transmitted between the short text messaging devices of the originating user and plural recipient users.

15. In computer readable medium, a short text messaging application data structure supporting identification of a thread of short text messages in a mobile telephone network short text messaging system, comprising:
a short text message thread identifier that identifies the thread of short text messages; and
an identifier for an originating message user; and
an identifier for a recipient message user.

16. The medium of claim 15 in which the identifiers for the originating and recipient message users correspond to short message addresses for short text message devices associated with the originating and recipient message users.

17. The medium of claim 15 in which the identifier for the originating message user includes an originating tag and a separate short message address for a short text message device associated with the originating user.

18. The medium of claim 15 in which the identifier for the recipient message user includes a destination tag and a separate short message address for a short text message device associated with the recipient user.

19. In a mobile telephone network short text messaging system, a method of associating a message from a message originator having a first network address with plural message recipients that each have a unique network address to facilitate replies to the message, comprising:
generating a message thread identifier that identifies the message and is of fewer digits than the first network address;
populating a data store with association information that includes the message thread identifier in correlation with the first network address and the unique network address of each of the plural message recipients;
transmitting the message to each of the plural message recipients with the message thread identifier; and
transmitting a reply message from at least one of the plural message recipients according to the message thread identifier so that the reply message is delivered to the message originator and each of the other message recipients by virtue of the association information in the data store.
